(19) United States
(12) Patent Application Publication
(10) Pub. No.: US 2009/0094525 A1
(43) Pub. Date: Apr. 9, 2009

(54) SYSTEM AND METHOD FOR DYNAMIC MEDIA INTEGRATION INTO WEB PAGES

(75) Inventors: Zachery Keplinger Coelius, San Francisco, CA (US); Ryan Tecco, San Francisco, CA (US); Susan Coelius Keplinger, San Francisco, CA (US)

Correspondence Address: SCHWEGMAN, LUNDBERG & WOESSNER, P.A., P.O. BOX 2938, MINNEAPOLIS, MN, 55402, US

(73) Assignee: Triggit, Inc.

(21) Appl. No.: 11/868,291

(22) Filed: Oct. 5, 2007

(51) Int. Cl. G06F 3/00

(52) U.S. Cl. 715/741

(57) ABSTRACT

Systems and methods for dynamic media integration into networked content are disclosed. The system in an example embodiment includes components to insert a trigger into publisher media, receive a request for access to a graphical user interface from a publisher, receive, via the graphical user interface, publisher instructions for modifying publisher media, create an annotation corresponding to the publisher instructions, and edit publisher web pages as view by a client browser when the trigger is activated.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2006-2007, Triggit, Inc. All Rights Reserved.

### BACKGROUND

1. Technical Field

This patent application relates to methods and systems supporting networked content. More particularly, the present disclosure relates to dynamic media integration into networked content.

2. Related Art

Existing systems provide techniques for manipulating web pages. However, conventional techniques for interacting with web pages are limited by their need to have some sort of code inserted into the source HTML, CSS, and other types of code of the web page. For example, it is common for conventional systems to insert an advertisement (ad) into a web page. To accomplish this ad insertion using conventional systems, the publisher must insert and customize a segment of code provided by the advertising partner into the publisher web page's source code. This code is then used to render an advertisement on a web page in the location on the page indicated by the code. Should the publisher want to move or modify the ad, alternate ads with other advertising partners or other media elements, set meta-data indicating to whom the ads should be displayed, or in any other way change the ad, the publisher must hard code those changes into the publisher site or code in processes that call to third party software providing an alternative interface for making these changes. This single example of placing an advertisement also correlates to the process of inserting any other third party content, media, applications, widgets or services. These problems fall into several categories as described below.

Media Editing: The current paradigm for creating or editing any sort of web page is to directly interact with the source code of the web page either by hand or with a software editor. The limitations arise when someone wants to make changes, optimize, target, insert third party media or in any way edit their web page. Currently, the only way to do this is to edit the existing source code—a cumbersome, slow, complicated process if done by hand. If the source code is edited using a conventional editor, possible changes are limited by the limits of the software and it is impossible to integrate many types of third party media, or to target specific elements. Moreover editing with a software editor still edits the underlying source code of the web page. One of the limitations of this method is its ability to make dynamic changes in response to the actions of the viewers of the web page.

Another limitation of current technologies is that they are too complex for most lay users to navigate. A large portion of current internet users are either unwilling or unsure about how to write, place, or edit code. As a result, there are many technologies and types of media that could be integrated and added to publisher's existing web page that are not because of the technical difficulty. This requirement of having to write or edit programming code leaves many non-technical users unable to fully interact with their media. More importantly, interaction with third party media that requires customization, placement, targeting, optimization, and analytics is nearly impossible for non-technical publishers. The ability for lay users to make changes to their web page and integrated third party media without having to interact with the source code of their web page at all make the whole process significantly easier.

Targeting: Currently publisher targeting of add-on media requires either the customization of the code, interaction with third party software, the implementation of third party software, or is impossible altogether. Moreover, each of these targeting elements needs to be dealt with on a case-by-case basis. Thus, targeting many types of ads, widgets, content, media such as videos, applications and other sorts of third party media on web pages can require substantial effort and is difficult to swap media in and out and to optimize placement.

Serving: All current serving technologies either serve additional media reflecting code placed in the publisher web page or they adjust the media based on an algorithm or system that then displays the changes in a location of the web page demarcated by code already inserted into the source code of the web page. None of the current serving technologies are able to substantially change what is served as a result of publisher direction. For example a third party media server would by publisher instruction be able to change the media being served within a specific location of the site but it would not be able to move the media to another location or remove it all together without altering the source code of the web page. Current serving technologies allow the changing of the media served, they still can only make changes within a predetermined portion of the media demarcated by code placed into the media's code. They are fundamentally limited by instructions of the code that is placed into the source code of the web page.

Optimization: Currently, the only technologies for dynamically and programmatically optimizing internet media on a web page are confined to optimizing internet media within a demarcated place on an internet web page. For example, a set of ads can be displayed and the one or few that are clicked on the most can be shown more frequently. There are no technologies for dynamically and programmatically optimizing an entire media object. Because it is impossible using conventional systems to edit the media without editing the code, it has been impossible to fully optimize media dynamically.

U.S. Pat. No. 5,948,061 discloses methods and apparatuses for targeting the delivery of advertisements over a network such as the Internet. Statistics are compiled on individual users and networks and the use of the advertisements is tracked to permit targeting of the advertisements of individual users. In response to requests from affiliated sites, an advertising server transmits to people accessing the page of a site an appropriate one of the advertisements based upon profiling of users and networks. However, the disclosed apparatus does not dynamically and programmatically optimize the placement of ads on the entire web page and is restricted by the limitations of the code placed on web pages to allow its action.

Thus, systems and methods for dynamic media integration into web pages that do not require repeated interaction with source code are needed.

### BRIEF DESCRIPTION OF THE DRAWINGS

Embodiments illustrated by way of example and not limitation in the figures of the accompanying drawings, in which:

FIGS. 1-4 illustrate examples of existing systems that provide techniques for manipulating web pages.

FIG. 5 illustrates a high-level architecture of an example system for dynamic media integration into a web page in an example embodiment.

Referring to FIGS. 6-10, a series of data processing operations in a particular embodiment is illustrated.

FIGS. 11-18 illustrate an example of the interaction between the publisher and the GUI of the DMI in a series of sample screen shots.

FIG. 19 illustrates the basic components of a particular embodiment of the DMI.

FIG. 20 illustrates the basic components of a particular embodiment of the GUI.

FIG. 21 illustrates the basic components of a particular embodiment of the backend component.

FIG. 22 illustrates the basic components of a particular embodiment of the analytics component.

FIG. 23 is a block diagram of a network system on which an embodiment may operate.

FIGS. 24 and 25 are block diagrams of an example computer system on which an embodiment may operate.

### DETAILED DESCRIPTION

Computer-implemented systems and methods for dynamic media integration into web pages are disclosed. In the following description, numerous specific details are set forth. However, it is understood that embodiments may be practiced without these specific details. In other instances, well-known processes, structures and techniques have not been shown in detail in order not to obscure the clarity of this description.

As described further below, according to various example embodiments of the disclosed subject matter described and claimed herein, there is provided computer-implemented systems and methods for dynamic media integration into web pages. The system includes a dynamic media integrator. Various embodiments are described below in connection with the figures provided herein.

### Conventional Implementations

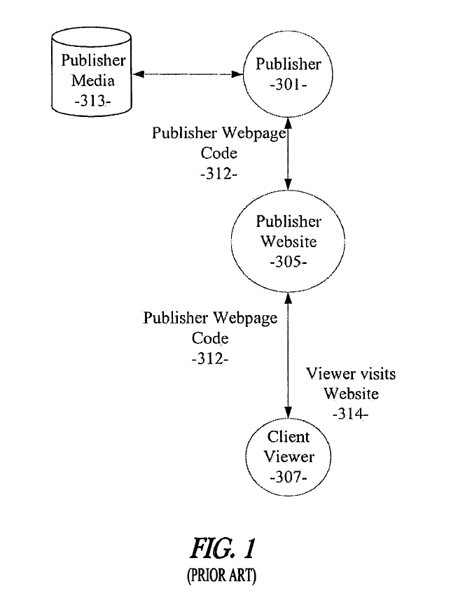

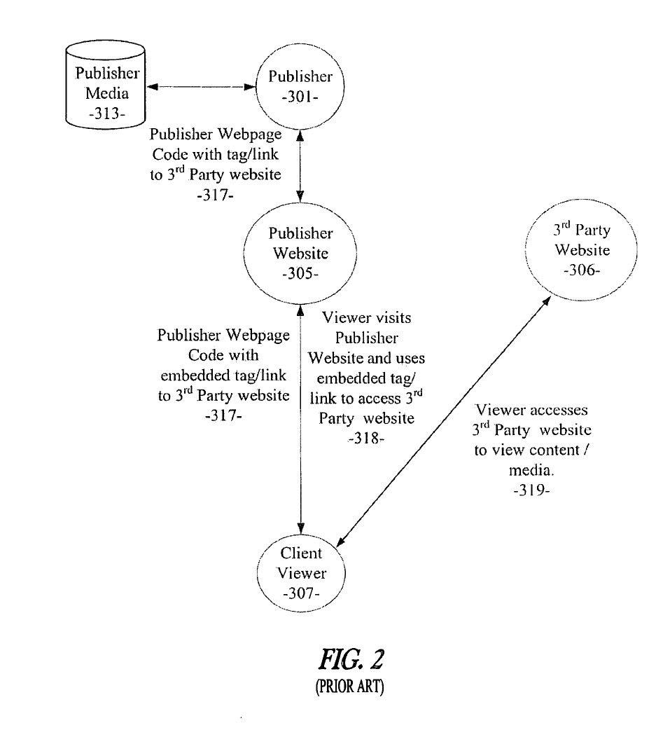

Referring to FIG. 1, existing systems provide techniques for manipulating web pages. However, conventional techniques for interacting with web pages are limited by their need to be hard coded into the source code of the web page. For example, in conventional network publishing systems, a publisher 301 can generate code for a web page 312, a portion of which may be stored on and retrieved from publisher database 313. The code of the web page 312 can then be published on a publisher website 305 and made accessible to networked clients/user via a client viewer 307 (e.g. a conventional browser). The client viewer 307 can retrieve the code and/or media (e.g. web pages) 312 from publisher website 305 and render the content on a client system. In one example, the code and/or media (e.g. web pages) 312 can be coded in a conventional hypertext markup language (HTML) or cascading style sheets (CSS).

Referring to FIG. 2, a variation on existing systems provides another technique for manipulating websites. In this implementation, the publisher 301 can insert code tags or links (e.g. often called embed code) into the publisher's code of their web page 317. The embedded tags/links can be used by the client viewer 307 to access a 3^{rd} party website 306 when the code of the publisher web page 317 is processed for viewing on the client system by the client viewer 307. In this manner, the publisher can hard code into the publisher's web page a link to 3^{rd} party media that will be displayed on the client viewer as part of the web page. For example a tag could call to a third party web site instructing the third party web site to transmit a picture for display in the web page. The client view would then display that picture in the web page as a single page even though the underlying code/content portions of the web page came from multiple places. Moreover, this type of process can be used to enable numerous effects, such as embedding videos, software applications, pictures, advertisements and more into the publisher's web page 317.

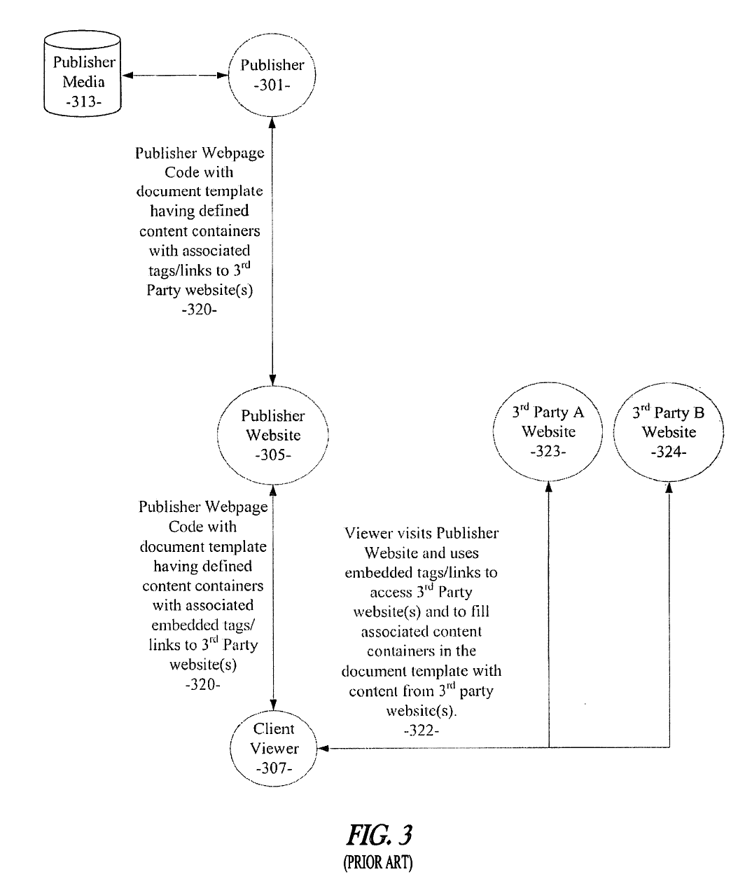

Referring to FIG. 3, another variation on existing systems provides another technique for manipulating web pages. In this implementation, the publisher 301 can generate the publisher's code for her web page 320 as a document template having defined content containers (e.g. display regions within the webpage at a particular location and of a particular size). Each defined content container can have an associated tag/link to a 3^{rd} party website from which the content for the associated content container is retrieved by the client viewer 307. In particular, when the client viewer 307 accesses the publisher website 305, the client viewer 307 can directly render on the client system portions of the publisher webpage that are not within a defined content container. For the portions of the publisher webpage that are within a defined content container, the client viewer 307 obtains the tag/link associated with each content container, uses the tag/link to access the corresponding 3^{rd} party website, obtains the content from the 3^{rd} party website, and inserts the 3^{rd} party content into the corresponding content container on the publisher webpage being rendered on the client system. In this manner, the publisher can create specific hard-coded regions into which 3^{rd} party content can be inserted when the publisher webpage is rendered by the client viewer 307. Moreover, the actual content that is displayed within these containers can be changed and manipulated by the third party web site 323 or 324 without input by the publisher beyond the initial insertion of code demarcating container size, location, appearance and the like.

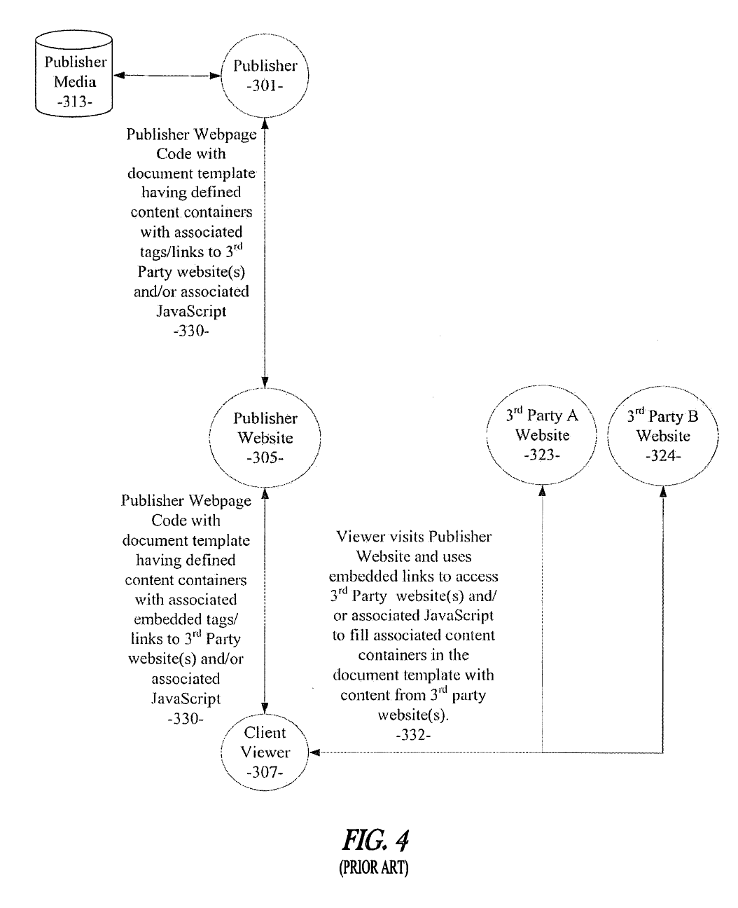

Referring to FIG. 4, another variation on existing systems provides yet another technique for manipulating web pages. In this implementation, the publisher 301 can use conventional JavaScript in combination with the techniques described above in connection with FIG. 3. A primary use of JavaScript is to write functions that are embedded in or included from HTML pages and interact with the view of the page in a dynamic fashion. Some simple examples of this usage include, 1) opening or popping up a new window with programmatic control over the size, position and ‘look’ of the new window (i.e. whether the menus, toolbars, etc. are visible), 2) validation of web form input values to make sure that they will be accepted before they are submitted to the server, or 3) changing images as the mouse cursor moves over them. This effect is often used to draw the user's attention to important links displayed as graphical elements. Because JavaScript runs on the client rather than the server, JavaScript can respond to user actions quickly, making an application feel more responsive. Furthermore, JavaScript code can detect user actions which HTML alone cannot, such as individual keystrokes. Some applications use JavaScript to implement user-interface logic with JavaScript being enabled to dispatch requests for information (such as the content of a portion of a webpage) to the server of that webpage. In other implementations, Ajax programming similarly seeks to exploit JavaScript's strengths. One limitation of this variation is that the publisher has no control over the effect created by the Javascript. Once the initial code is inserted into the web page, the code placed controls the effect. Therefore, if the publisher wants to remove, modifiy or in some way update the effect, she needs to edit or insert new Javascript to reach that outcome. Another limitation is placing the Javascript often requires customization to the publisher's website, whereby the publisher must modify the code in order to specify location, apperance, size and other such variables. Often, such interactions with the code are daunting for non-technical publishers and tedious for technical publishers.

In the implementation illustrated in FIG. 4, the publisher 301 can generate the publisher's code and/or media (e.g. web pages) 320 as a document template having defined content containers (e.g. display regions within the webpage at a particular location and of a particular size). Each defined content container can have an associated tag/link to a 3^{rd} party website from which the content for the associated content container is retrieved by the client viewer 307. In addition, each defined content container can have an associated JavaScript component (e.g. a portion of executable JavaScript programming code) that is executed by the client viewer 307 when the associated content container is processed by the client viewer 307. The JavaScript component can be used to perform a level of data processing on the 3^{rd} party content prior to insertion of the 3^{rd} party content into the corresponding content container.

In each of the conventional implementations described above, the publisher is limited in the level of complexity that can be coded into the publisher's web pages. If the publisher chooses to incorporate 3^{rd} party content into the publisher's web pages, the publisher must generate specific code to provide content containers into which 3^{rd} party content can be inserted. The generation of this publisher code is tedious and may be complex and error-prone. As such, the structure of conventional publisher web pages tends to be static and not conducive to dynamic alteration.

### Overview of Various Embodiments

One goal of the various embodiments described herein is to enable a publisher to seamlessly edit their web pages, integrate 3^{rd} party content, integrate additional or ancillary content, provide data services, integrate advertising or any other media into their web pages with a minimal one time insertion of very small amount of code (denoted herein as trigger code). As used herein, the terms, “added media”, “dynamic media”, 3^{rd} party media, or 3^{rd} party content refer to these varied additional elements that are integrated into web pages. As used herein, the terms, “networked content” or “publisher media” refer to web pages. Using the various embodiments described herein, a publisher can edit, target with meta-data, optimize, collect data, analyze data, and otherwise interact with the web pages and added media without interacting with the source code after one initial insertion of bootstrap code.

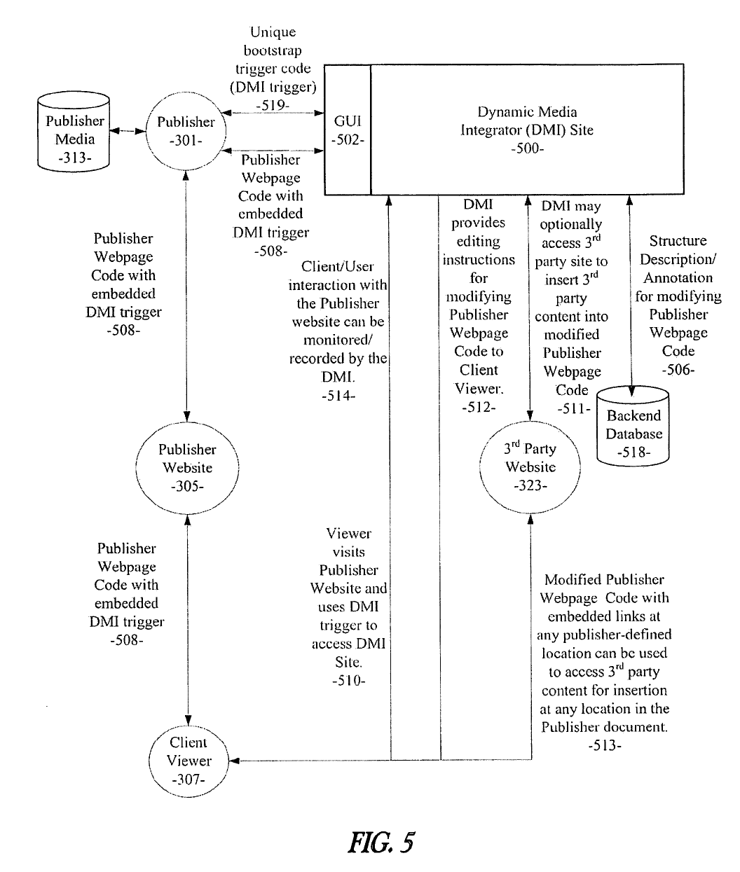

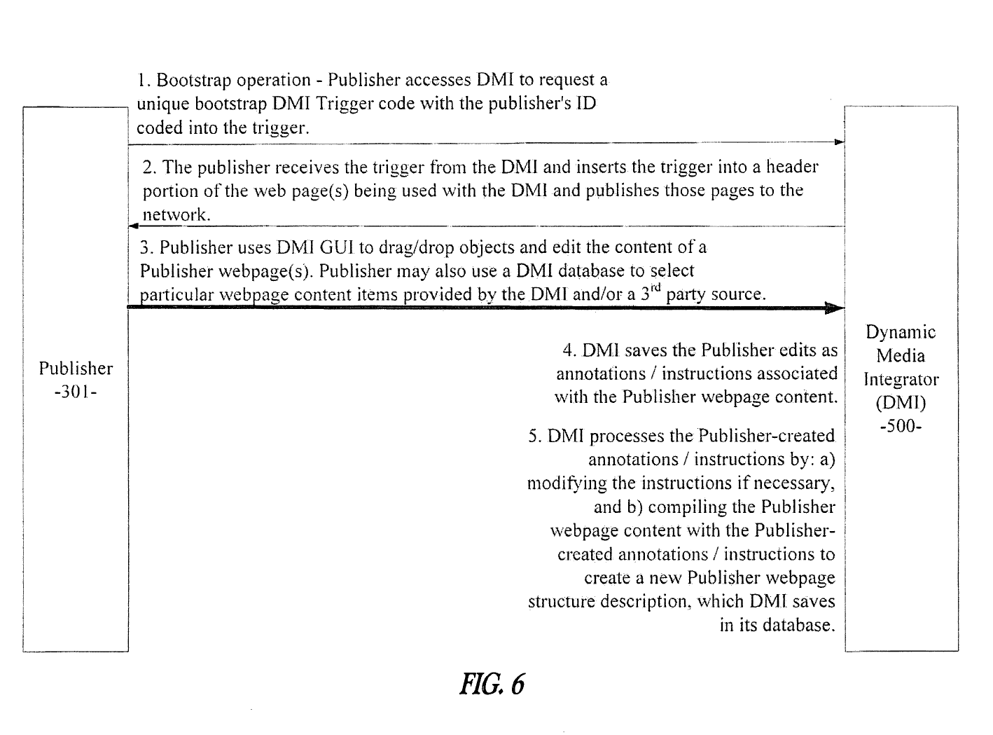

Referring to FIG. 5, a high-level architecture of an example system for dynamic media integration into web pages in an example embodiment is illustrated. As shown, a Dynamic Media Integrator (DMI) component 500 (e.g. a website) is shown in networked data communication with a publisher 301 and a client viewer 307. The DMI 500 is shown to include a graphical user interface 502 through which the publisher 301 may interact with the DMI 500 to create or edit publisher web page. One function of the various embodiments described herein from the publisher's 301 perspective can be thought of as a user interface 502 that removes the need for the publisher to operate at the level of the software code for the editing and manipulation of the publisher's web page (such as HTML, CSS, etc). Using this method, the publisher can make changes to the website without changing the website source code. Interacting with the Graphical User Interface (GUT) 502 of the various embodiments described herein, the publisher 301 is able to drag and drop objects, insert various templates, use editing tools, highlight and click on text, images, videos or any object in the publisher media to associate the object with added media or 3 party content such as ads, mouse over pop ups, data services like mapping, widgets, and all manner of application programming interfaces (API's). Using the various embodiments described herein, the publisher 301 is able to edit the web page(s) or publisher media 313 and change the shape, size, color, sound, or appearance in any manner. In advertising for example, the various embodiments described herein can be used to link advertisements (e.g. one form of added media) from an advertiser (e.g. 3^{rd} party website 323) with objects in the publisher web page 504 in a manner that enables users interested in the object to see additional information in the form of a link, mouse over popup, sidebar, or dynamic widget. As a page editing function, the publisher 301 can achieve similar functionality of a traditional HTML (hypertext markup language) or other type of media editor without actually interacting with or even altering the source code.

As shown in FIG. 5, a publisher 301 can initially interact with DMI 500 using GUI 502. The DMI 500, using the GUT 502, provides the publisher with a unique bootstrap code with a DMI trigger 519 to be inserted in the publisher's web page 508 or into the header section of each of the web pages on the Web Site 305 so that the DMI Trigger 519 will be embedded in all of the publisher's web pages. Once the DMI trigger 519 has been inserted into the publisher's web page 508, the web page 508 can be published to a server (e.g. publisher website 305) and made accessible to the web. Once the DMI trigger 519 has been inserted, the Publisher 301 can use a client viewer to access the DMI 500 and the GUT 502. Using the DMI 500 and the GUI 502 as a shell, the publisher 301 can view her web page 508 as published on the publisher website 305. Viewing the web page 508 through the DMI 500 enables the publisher to indicate changes to be made to the web page 508 that can be displayed through the GUT 502 as mockup of what the web page would look like with the indicated changes active. If the publisher approves of the changes, they can then be recorded by the DMI 500 as instructions for modifying or augmenting the web page 508. These changes and the associated instructions for implementing the changes may include any of the types of edits described above. The DMI 500 may also optionally access 3^{rd} party sites 323 and display 3^{rd} party content where the publisher may then select various objects of third party content and insert the selected third party objects into the mockup of the web page 508 as displayed by the GUT 502. These instructions for modifying or augmenting the web page 508 are processed by the DMI 500 by recording the current existing state of the web page 508 and compiling the web page with the instructions given to the GUT 502 by the publisher to create new code reflecting the desired changes. This new code is stored as Structure Descriptions/Annotations 506 and is associated with the publisher's 301 unique DMI trigger 519. The resulting structure description or annotation 506 can be stored in a backend database 518, in a file system, in a dynamic cache, or in random access memory.

When a client viewer 307 accesses the publisher’ web page 508 with the DMI trigger 519 on the publisher site 305, the client viewer 307 is instructed by the DMI trigger 519 to access the DMI site 500. The DMI 500 retrieves the annotation 506 associated with the publisher web page 508 and sends the annotation 506 to the client viewer 307. The client viewer 307 then applies the modifications specified by the annotations 506 to the web page 508 as the webpage is rendered by the client viewer 307. These modifications specified by the annotations 506 modify the web page 508 as the web page is viewed in the client viewer 307. In this manner, the publisher web site 305 reflects the changes indicated by the publisher 301 and recorded as annotations 506. These modifications may include, but are not limited to, any of the edits described above. Additionally, the modifications specified by the annotations 506 can enable inserting links to 3^{rd} party sites 323 for accessing 3^{rd} party content that may be inserted into portions of the publisher web page 508 as defined by the annotation 506. The DMI 500 may also optionally access 3^{rd} party sites 323 and insert 3^{rd} party content into the publisher web page code 508. The editing instructions 512 for modifying the publisher web page code are provided to the client viewer 307. The client viewer 307 can then use the 3^{rd} party links embedded in the editing instructions 512 for modifying the publisher web page code to access 3^{rd} party 323 content for insertion into portions of the publisher web page code 508 as defined by the annotation 506. Because of the flexibility of the structure description/annotation 506, the publisher web page 508 can be modified in any way as specified by the instructions given by the publisher 301 when the annotation 506 is created and applied by the DMI 500. As such, the various embodiments described herein are not constrained by a pre-defined set of content containers. Further, because the client viewer 307 initially makes access to the DMI 500, the client/user interaction with the modified publisher web page 508 can be monitored and recorded by DMI 500 in operation 514. The information defining the client/user interaction with the modified publisher web page code 508 can be stored in backend database 518. This information can be included in a set of analytics that may assist the publisher and the 3^{rd} party content provider to create content that serves pre-defined objectives.

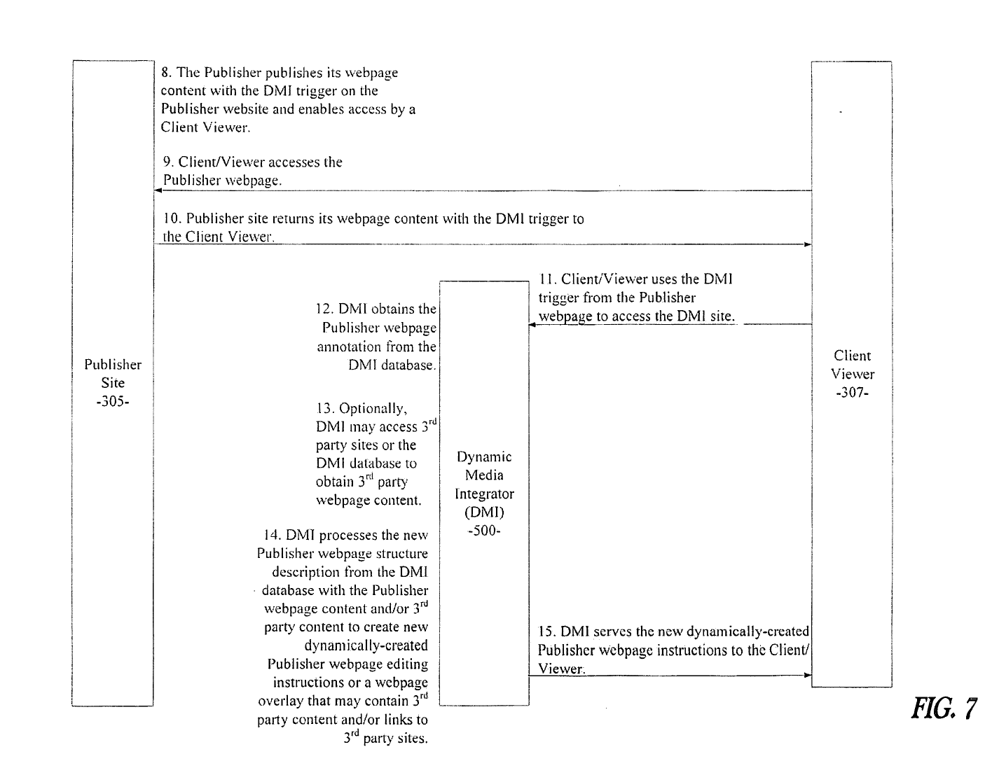

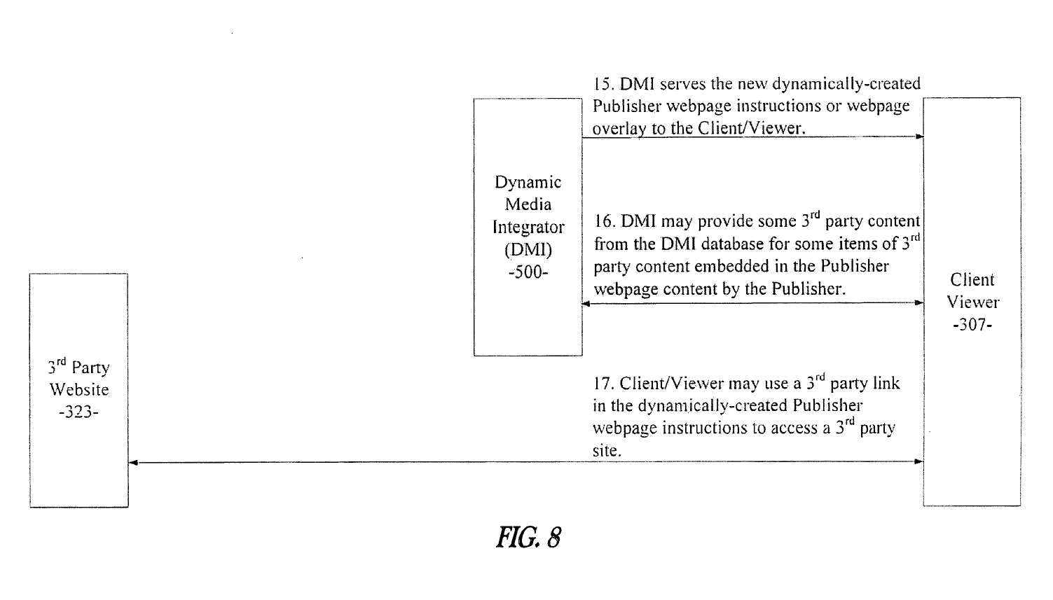

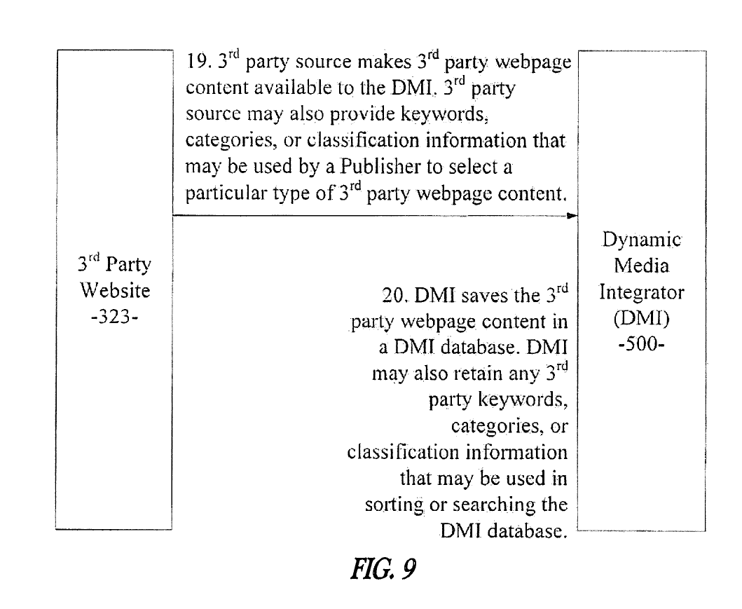

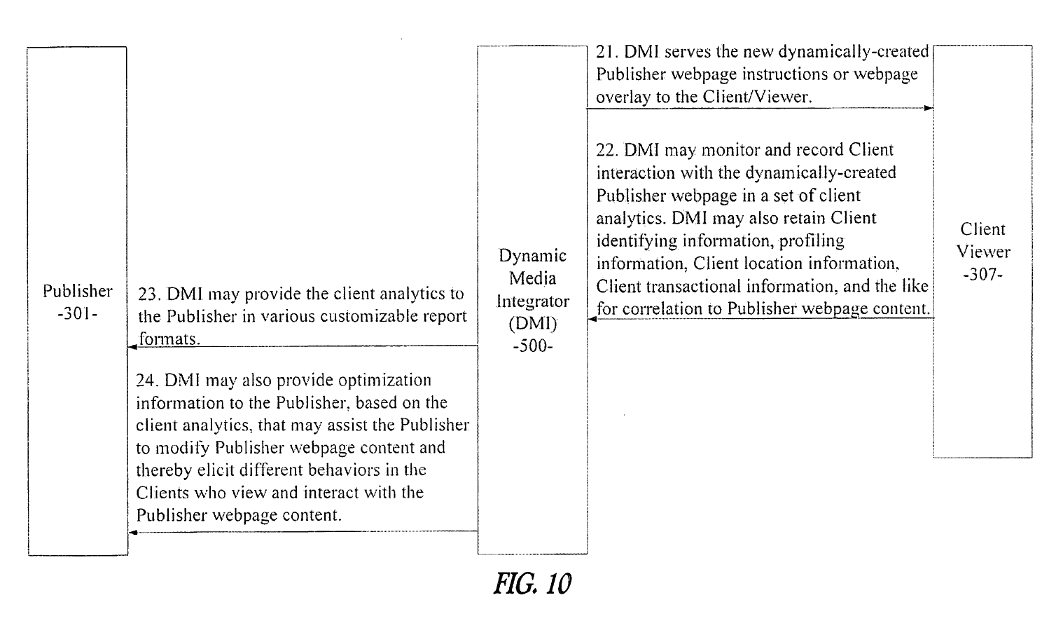

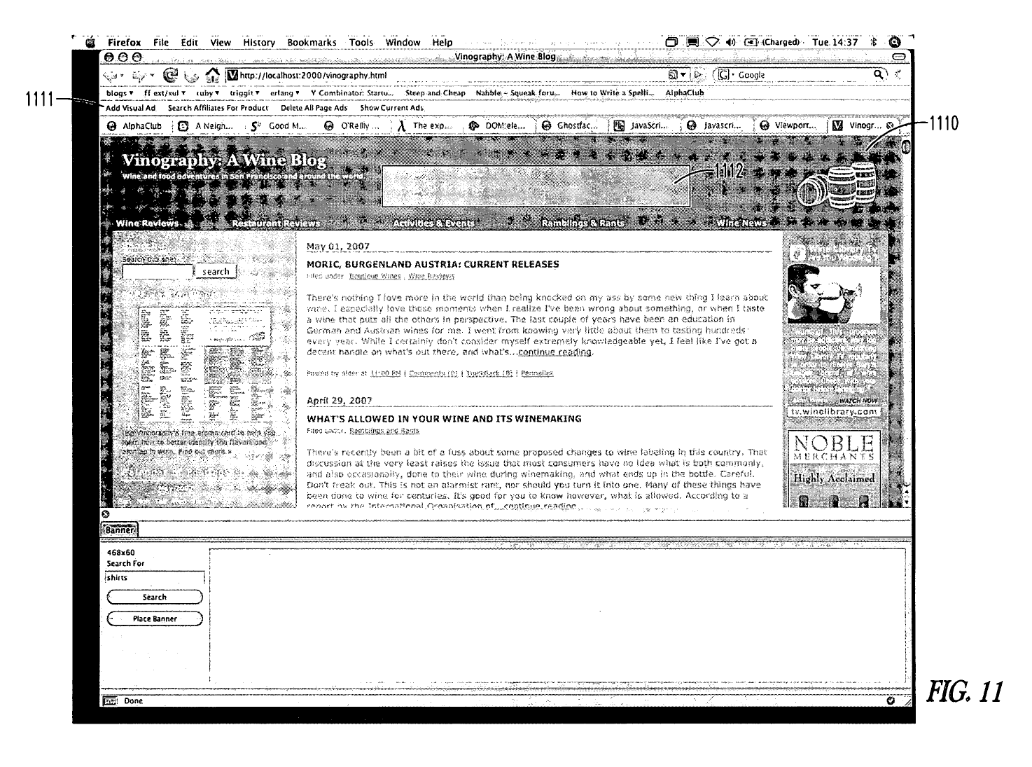

Referring to FIGS. 6-10, a series of data processing operations in a particular embodiment is illustrated. FIG. 6 illustrates an interaction between the publisher 301 and the DMI 500 to create editing instructions 512 for modifying the publisher web page code. In a first bootstrap operation, the publisher 301 accesses DMI 500 to request a unique bootstrap DMI Trigger code 519 with the publisher's ID coded into the DMI trigger 519. Upon receiving the DMI trigger 519 from the DMI 500, the publisher 301 then inserts the DMI trigger 519 into a header portion of the publisher web page(s) with which she wishes to use the DMI 500. When the DMI trigger 519 is embedded into the publisher web page(s), the publisher 301 publishes those modified web page(s) on a publisher website 305, which is accessible by others via the Internet. Once the DMI Trigger code 519 is inserted and the modified web page(s) are published, the publisher 301 can use a browser to access the DMI Site 500. Using the DMI 500 as a shell, the Publisher 301 can then open the web pages she wishes to edit using the DMI 500 and GUI 502. Using the DMI 500 as a shell enables the DMI 500 to record the current source code of the site being edited as well as to display to the publisher changes made to the web page(s) in a WYSIWYG (what you see is what you get) view. In a series of interactions with their web page 508 through the DMI 500 shell in operation 3 shown in FIG. 6, the publisher 301 can drag/drop objects, specify the insertion of 3 party content, and generally edit the content of a publisher webpage. The publisher 301 may also use a DMI 500 database (e.g. backend database 518) to select particular webpage content items provided by DMI 500 and/or a 3^{rd} party source. The interaction between the publisher 301 and the DMI 500 is described in more detail below in connection with the screen shots of FIGS. 11—18.

As the publisher 301 interacts with the DMI 500 to create editing instructions 512 for modifying the publisher web page code, DMI 500 builds a structure description or annotation 506 that describes the modifications specified by the publisher 301. These annotations are saved in the backend database 518 in operation 4 shown in FIG. 6. Once the publisher 301 has completed the specification of modifications to current published web page 508 as captured in the annotations 506, the DMI 500 can process the publisher-created annotations 506 by compiling Publisher webpage content 508 with the Publisher-created annotations/instructions 506 to create a Publisher webpage-specific structure description or annotation code 506, which DMI 500 saves in its backend database 518.

FIG. 7 illustrates an interaction between the publisher site 305 and the client viewer 307. In operation 8, the publisher 301 posts the publisher webpage code with the DMI trigger 508 on the publisher website 305 and enables access by a client viewer 307. In operation 9, a client viewer 307 accesses the webpage code with the DMI trigger 508. In operation 10, the publisher website 305 returns its webpage content with the DMI trigger 508 to the client viewer 307. In operation 11, the client viewer 307 uses the DMI trigger from the publisher webpage to access the DMI site 500. In operation 12, the DMI 500 obtains the annotation 506 associated with the DMI trigger and the publisher web page 508 accessed by the client viewer 307. The DMI 500 may optionally access 3^{rd} party webpage content or the DMI database 518 to obtain stored webpage content and/or 3^{rd} party webpage content in operation 13. In operation 14, the DMI 500 uses the annotation 506 to process the publisher webpage code 508 to create new dynamically-created publisher webpage editing instructions 512 or a webpage overlay that may contain 3^{rd} party content and/or links to 3^{rd} party sites. These dynamically-created publisher webpage editing instructions 512 are served to the client viewer 307 in operation 15. The client viewer 307 then processes these instructions 512 to make edits to the web page 508. These edits conform to the edits specified by the publisher 301 when the publisher 301 used the DMI 500 to specify modifications to the publisher webpages 508.

FIG. 8 illustrates an interaction between the client viewer 307, a 3^{rd} party site 323, and the DMI 500. In operation 15, the publisher webpage editing instructions 512 are served to the client viewer 307. The dynamically-created publisher webpage instructions 512 may contain 3^{rd} party content provided by the DMI database 518 (operation 16). The dynamically-created publisher webpage instructions 512 may also contain 3^{rd} party content provided by a 3^{rd} party site 323. In this case, the client viewer 307 uses the link embedded in the dynamically-created publisher webpage instructions 512 to access the 3^{rd} party site 323 and obtain 3^{rd} party content for insertion into the publisher webpage 508 (operation 17). As a result, the dynamically-created publisher webpage 508 as modified by the instructions 512 and optionally with 3^{rd} party content inserted at publisher-specified locations is displayed for a client/user by the client viewer 307.

FIG. 9 illustrates an interaction between the DMI 500 and a 3^{rd} party site 323. In operation 19, a 3 party source may make 3^{rd} party webpage content available to the DMI 500 for insertion into publisher web pages. The 3^{rd} party source may also provide keywords, categories, or classification information that may be used by a Publisher to select a particular type of 3 party webpage content for insertion into publisher web pages. One example of such 3^{rd} party webpage content is an advertisement. In operation 20, the DMI 500 receives the 3^{rd} party webpage content from 3^{rd} party site 323 and saves the 3^{rd} party webpage content in the DMI database 518. Additionally, DMI 500 saves the associated keywords, categories, or classification information corresponding to the 3^{rd} party webpage content in the DMI database 518. As part of the GUI 502, DMI 500 may allow a publisher 301 to query the database 518 and search for desired/relevant 3^{rd} party content using the keywords, categories, or classification information as related to the publisher webpage code.

Another method of achieving this same result in an alternative embodiment is the use of an application programming interface (API) to access 3^{rd} party websites 323 in real time to obtain 3^{rd} party content available for integration into the publisher's webpage. In this embodiment, a publisher 301 makes a request using the GUI 502 for content that matches certain specifications, such as keyword, size, type, search query or any other type of meta information. Using this data, the DMI 500 can query a third party database or 3^{rd} party websites using 3^{rd} party API's in real time for that type of content. If the specified 3^{rd} party content is available, the GUI 502 then displays 3^{rd} party content located in 3^{rd} party websites. In this embodiment, the annotations 506 created include directions for retrieving the specified content from the third party website when that content is required.

FIG. 10 illustrates an interaction between the DMI 500, the client viewer 307, and the publisher website 305. In operation 21, the dynamically-created publisher webpage instructions 512 or webpage overlay is served to the client viewer 307 by DMI 500. Because the client viewer 307 initially makes access to the DMI 500 using the DMI Trigger 519, the client/user interaction with the publisher webpage 508 as modified by instructions 512 can be monitored and recorded by DMI 500 in operation 22. This information may include, but is not limited to, visits to the media by the client/user, time spent, clicks, mouse movement, interaction patterns and data entered, scrolling, searches, and any other way that a user/consumer might interact with the publisher web page 508. The information defining the client/user interaction with the publisher webpage 508 as modified by instructions 512 can be stored in backend database 518. Additionally, the DMI 500 may also retain other information, such as client identifying information, profiling information, client location information, client transactional information, and the like for correlation with publisher webpage content. This information can be included in a set of analytics that may assist the publisher and the 3^{rd} party content provider to create content that serves pre-defined objectives. In operation 23, these client analytics may be provided to the publisher 301 by the DMI 500. Additionally, DMI 500 may process the client analytics to create optimization information that may assist the publisher 301 to modify the publisher webpage content and/or 3^{rd} party content to elicit different behaviors from the clients/users who view and interact with the publisher webpage content.

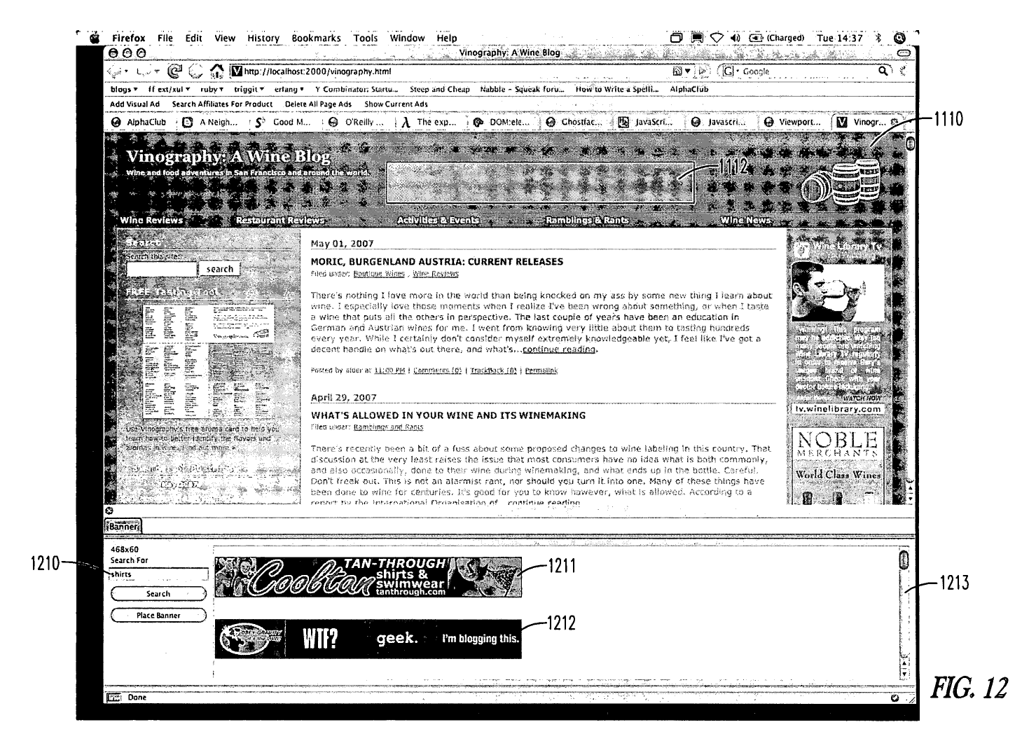

FIGS. 11-18 illustrate an example of the interaction between the publisher 301 and the GUI 502 of DMI 500 in a series of sample screen shots. In FIG. 11, an example of a publisher webpage 1110 is illustrated. After a publisher 301 has established a connection with the GUI 502 as described above, the GUI 502 can assist the publisher to define modifications to the publisher webpage 1110. GUI 502 provides a set of functions that enable a publisher 301 drag/drop objects in webpage 1110, specify the insertion of 3^{rd} party content into webpage 1110, and generally edit the content of the publisher webpage 1110. One such function is the Add Visual Ad function 1111 that can be activated by placing a pointing device (e.g. mouse) cursor in proximity to the Add Visual Ad function 1111 button and selecting the function. As a result, the publisher 301 is enabled to specify an arbitrary region 1112 within the webpage 1110. This region may be of any shape, size, and location in webpage 1110. In the example of FIG. 11, a rectangular region 1112 has been specified by the publisher 301. Once the publisher 301 has specified region 1112, DMI 500 measures the size and shape of the publisher-specified region 1112 and searches DMI backend database 518 as well as other 3^{rd} party's websites 323 accessed through API's for 3^{rd} party content that matches the general size and shape of the publisher-specified region 1112. The publisher 301 may also qualify this search for 3^{rd} party content by specifying the particular keywords, categories, or classification information associated with the 3^{rd} party content. The search results are displayed for the publisher 301 as shown in FIG. 12.

FIG. 12 illustrates an example of a publisher 301 search for relevant 3^{rd} party content. In this particular example, the publisher 301 has entered the search term, “shirts” in a search field 1210. DMI 500 uses this search term to search the DMI backend database 518 and third party websites 323 for 3^{rd} party content that generally matches the entered search term(s) and matches the general size and shape of the publisher-specified region 1112. As a result in the example of FIG. 12, DMI 500 returns matching 3^{rd} party content, of which two items 1211 and 1212 are displayed. The scroll bar 1213 on the right side of the screen may be used to view additional search results. Publisher 301 may scroll through the search results and select a particular item of 3^{rd} party content for insertion into the publisher-specified region 1112. The resulting modified publisher webpage 1310 is illustrated in FIG. 13. Note that a matching item of 3^{rd} party content 1311 has been inserted into the publisher-specified region 1112.

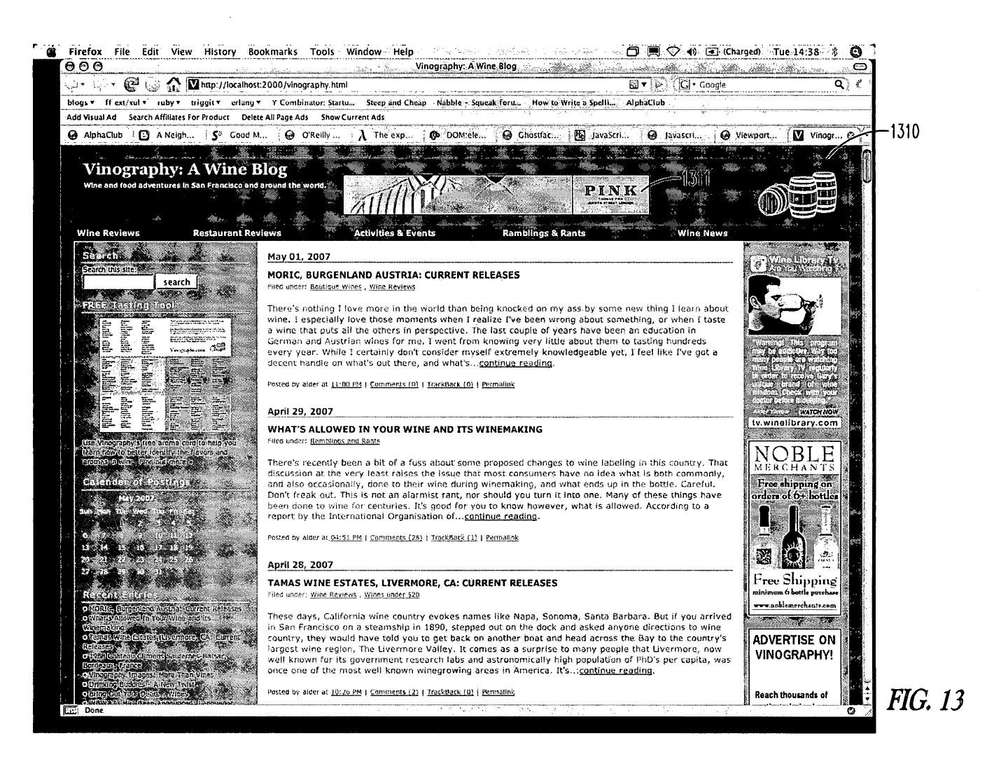

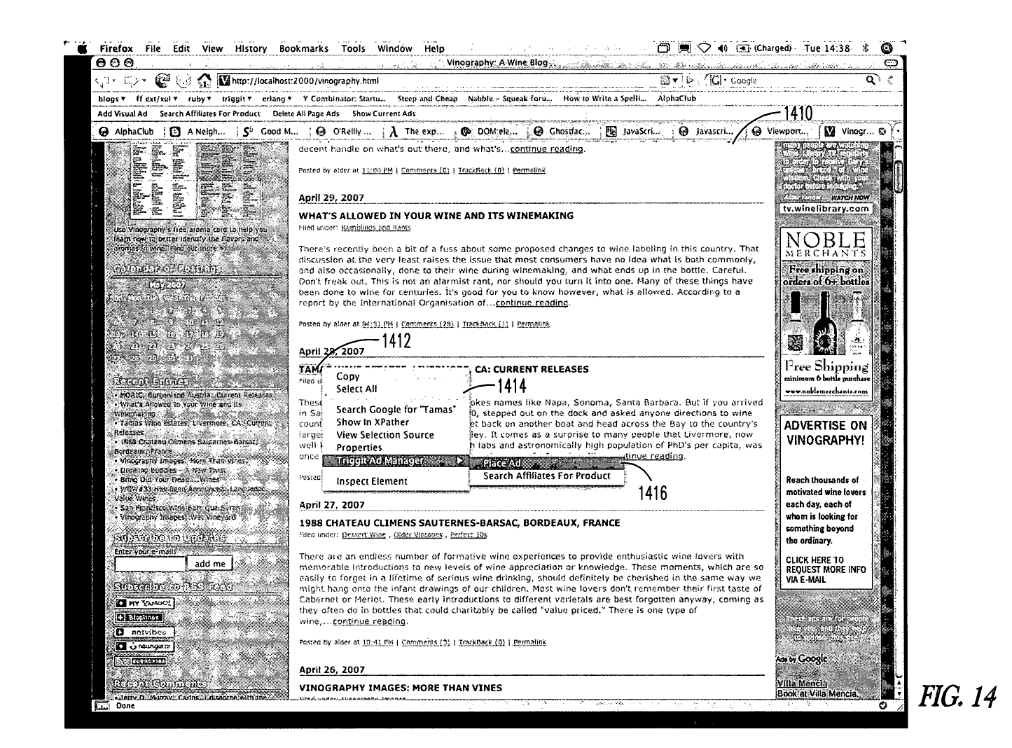

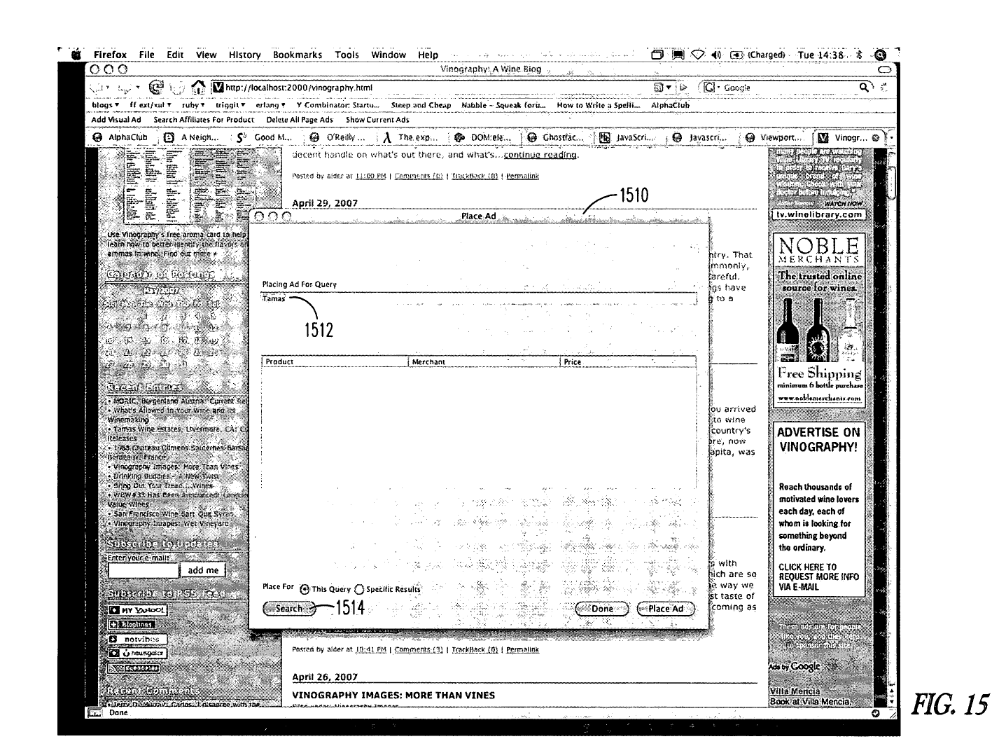

FIGS. 14-18 illustrate an example of modifying a particular object (e.g. a text string) in a publisher webpage. Referring to FIG. 14, a publisher webpage 1410 is displayed. Using functionality provided by the GUI 502 of DMI 500, the publisher 301 can select a particular object (e.g. a text string) in the publisher webpage 1410. In this particular example, the publisher 301 has selected the word, “Tamas” 1412 in webpage 1410. In this example, the publisher 301 wishes to attach an item of 3^{rd} party content to the selected word. As a result of this selection, the publisher 301 may right-click a mouse button to activate a menu of function selections 1414, one of which is a “Place Ad” function 1416. The publisher 301 may thereby activate the “Place Ad” function 1416. As a result of this selection, the “Place Ad” prompt, as shown in FIG. 15 is displayed.

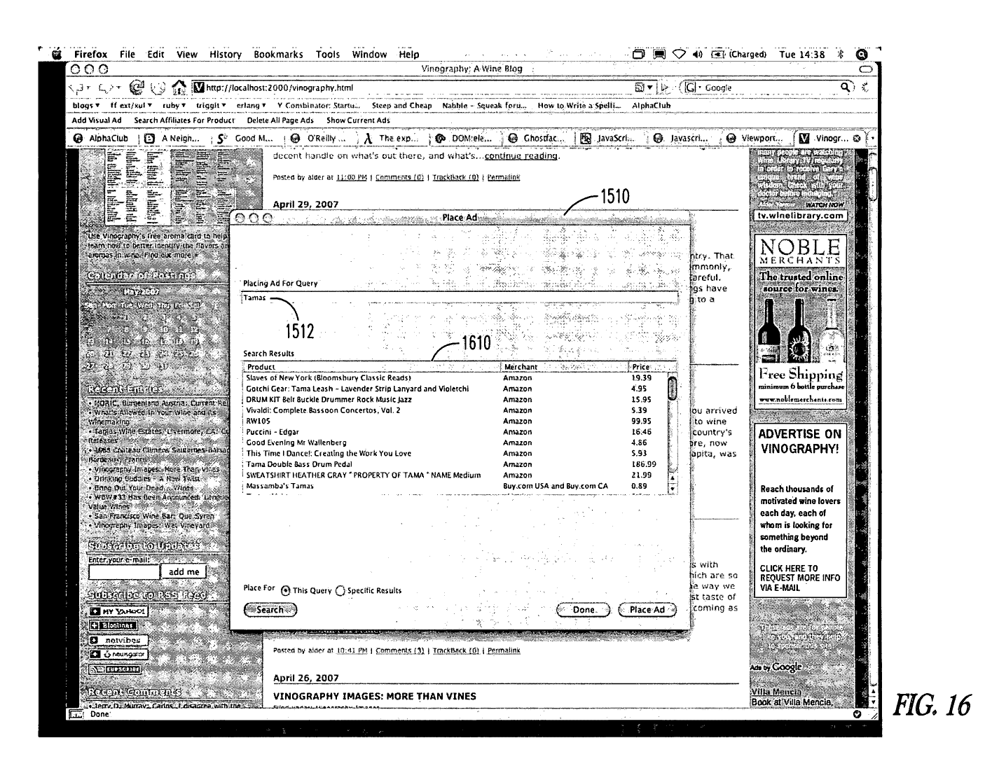

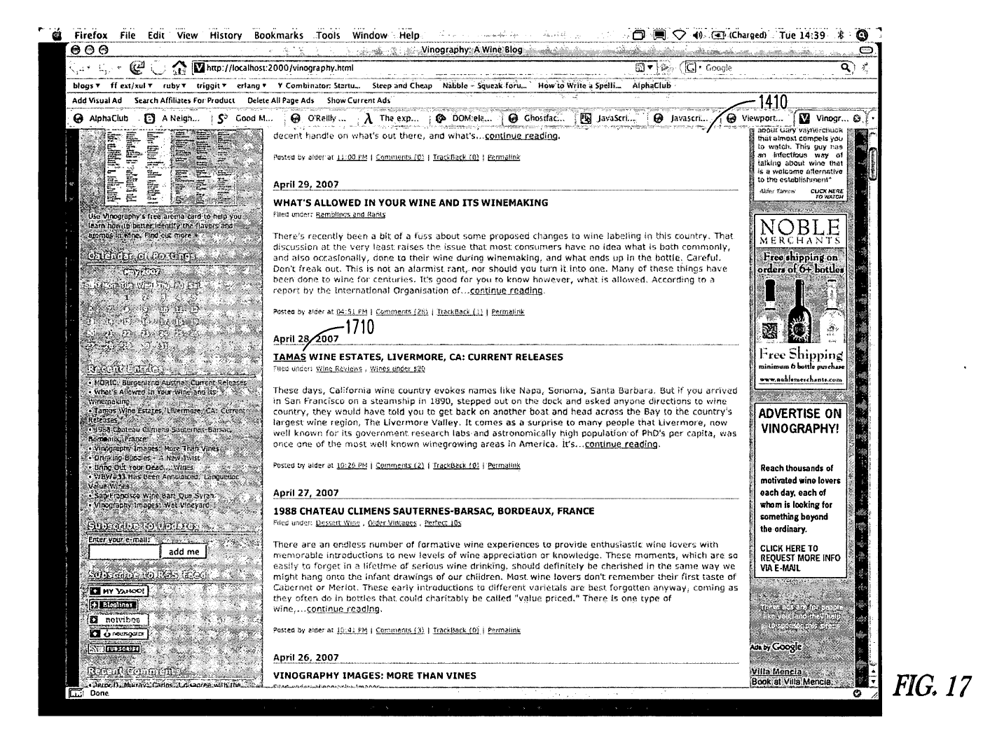

FIG. 15 illustrates the “Place Ad” prompt 1510 in a particular embodiment. Note that the publisher-selected word, “Tamas” has been pre-loaded into the search field 1512. The publisher 301 may initiate the search for 3^{rd} party content items matching the search term(s) entered in the search field 1512 by activating the “Search” button 1514. Alternatively, the publisher 301 can enter a new search term into search field 1512 and activate the “Search” button 1514. As a result, the DMI 500 searches the backend database 518 and third party web sites 323 for 3^{rd} party content that matches the entered search term(s). The search results are displayed in the search results region 1610 shown in FIG. 16. Each of the items listed in search results region 1610 represent particular items of 3^{rd} party content that match the entered search term(s). The publisher 301 can select any one of the items in the search results region 1610. Once the publisher 301 has selected a particular item of 3^{rd} party content from search results region 1610, the selected item of 3^{rd} party content is associated (e.g. linked) with the object 1412 previously identified in the webpage 1410. This linkage between the selected item of 3^{rd} party content and the identified object 1412 is represented as an underline placed under the identified object 1412 as shown in FIG. 17 as object 1710.

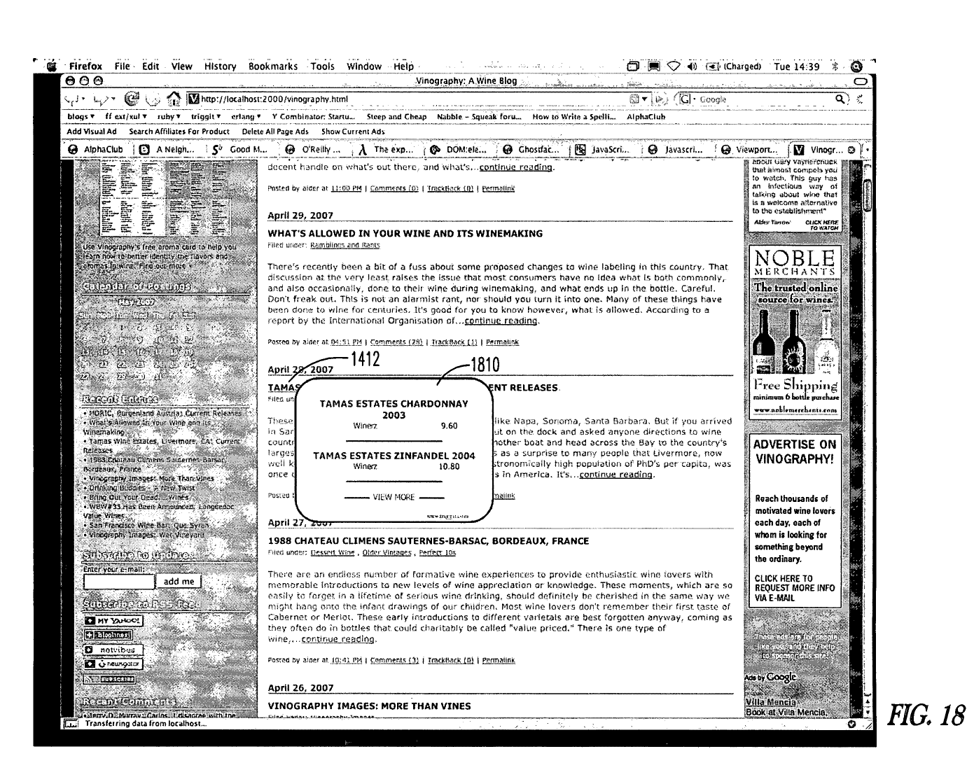

Once the linkage between the selected item of 3^{rd} party content and the identified object 1412 has been established as described above, the selected item of 3^{rd} party content can be displayed when an event occurs relative to the identified object 1412. Such events may include displaying the identified object 1412, performing a mouse-over of the identified object 1412, selecting the identified object 1412, and the like. In a particular example, FIG. 18 illustrates how the selected item of 3^{rd} party content 1810 is displayed when a mouse-over of the identified object 1412 is performed. Using other functions provided by the DMI 500, a previously established linkage between a selected item of 3^{rd} party content and an identified object 1412 can be removed.

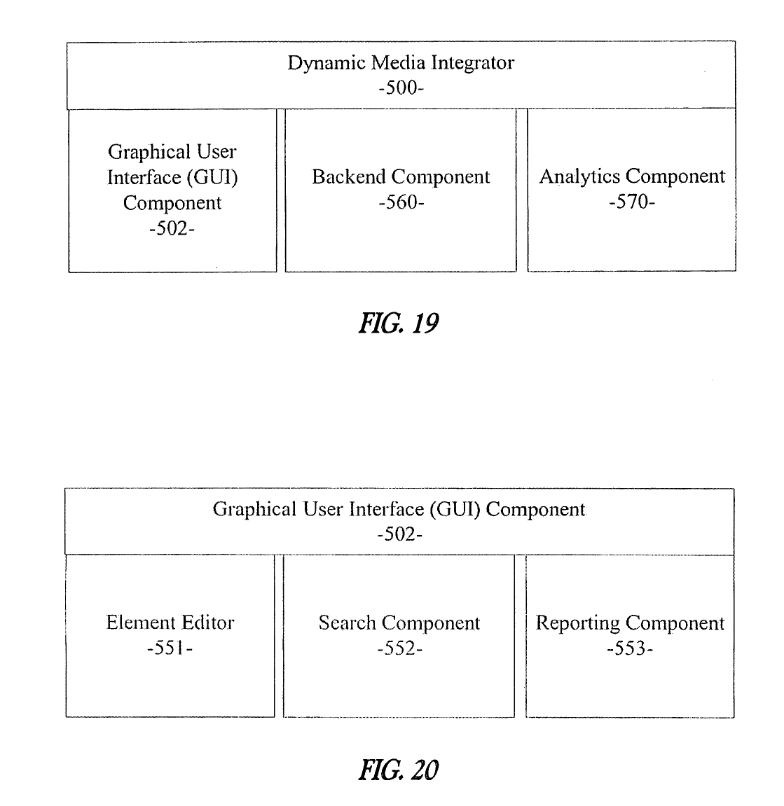

As will be described in more detail below and in connection with FIGS. 19-22, particular embodiments of DMI 500 are configured as three basic functional components: a graphical user interface component 502, a backend component 560, and an analytics component 570 as shown in FIG. 19. Each of these components of particular embodiments are described in more detail below.

Referring to FIG. 20, the components of a particular embodiment of the GUI 502 are shown. After adding the trigger code to publisher media source code, the Publisher 301 can access through a website the Graphical User Interface (GUI) component 502 of particular embodiments to graphically manipulate their publisher media (e.g. a webpage) without editing source code of the publisher media. DMI Trigger code 519 can be a simple reference or link to the DMI 500. In one embodiment, this trigger code is a URL associated with the DMI 500. The GUI 502 can be a web application that can be accessed by navigating to a Uniform Resource Locator (URL).

Using an element editor 551 of the GUI 502 as shown in FIG. 20, the publisher 301 can graphically manipulate and add/remove existing/embedded elements into/from their publisher media as described above. In particular, the publisher can:
a. Embed new elements into their publisher media. A publisher can insert any media elements, drag and drop these media elements to a new location in the publisher media, insert pre-defined templates of media elements, edit embedded elements in the publisher media, highlight and click on text, images, videos or any object embedded in the publisher media. As a result, the publisher can add media such as ads, mouse-over pop-ups, data services like mapping, widgets, and all manner of API's to existing publisher media.
b. Graphically edit any existing elements and media as well as any embedded elements and other media. Edits can include, but are not limited to: changing the physical appearance in shape, size, color, sound, speed; moving elements around the page using drag and drop functionality; removing or hiding embedded elements; copying, cutting, pasting elements to or from another location.
c. Attach new media to existing or embedded elements. For example, if a publisher selects an element, they can attach a piece of media to result in a particular action when a visitor of their site takes some action on that element, such as mouse-over, clicks on, etc.

Using a search component 552 of the GUI 502 of particular embodiments, publishers can search the backend database 518 as well as third party websites to interact with any media accessible to particular embodiments. For example, publishers can:
a. Search the backend database 518 for added media objects to embed in networked content. Added media objects can include, but are not limited to, advertisements, audio, video, image files, and any sort of data file that can be placed in networked content.
b. Search third party websites 323 and by extension their databases for added media objects to embed in networked content. Added media objects can include, but are not limited to, advertisements, audio, video, image files, and any sort of data file that can be placed in networked content.

Using a reporting component 553 and the backend component 560, the GUI 502 provides the ability to report data gathered by the analytics component 570 thus enabling the publisher to view information related to the Visitor's interaction with the content/media. In particular, the GUI 502 provides the following features:
a. Data reporting
   i. Presentation of performance within the GUI.
      1. This includes reporting mechanisms such as a report with data hovering over the respective elements on the networked content.
      2. Ticker in the corner of a display screen showing performance/cash/other measures.
      3. Analysis of performance can also be presented using graphs, spreadsheets and other standard presentation techniques.
   ii. Predictive reporting. Suggestions can be automatically made by the various embodiments to provide information related to the potential outcomes to changes.
   iii. Template/layout recommendations can be made by particular embodiments.
b. Ability for a publisher to create a test environment surrounding elements.
   i. A Publisher can define one or more elements and create tests using various embodiments. For example, if a Publisher wanted to test the performance of a particular call to action on a button, they can define that element and associated multivariate test performance criteria.
b. Ability to create dependant relationships. If a visitor takes one action, the elements may be configured to appear one way, if the visitor takes another action, the elements could be configured to appear in a different way.

Once changes to the networked content are specified using the GUI 502, annotations associated with the networked content are saved by the DMI 500 of a particular embodiment. Once the networked content is accessed, annotations made through the GUI 502 are applied to the networked content and the result is displayed to a client/user.

Referring to FIG. 21, the components of a particular embodiment of the backend component 560 are shown. One function of the backend component 560 in a particular embodiment is to retrieve, organize, store, and transmit data and media stored in backend database 518 in support of the GUI component 502. This data and media includes, but is not limited to, elements such as, software code, software widgets, images, advertisements, rich media, maps, web applications and any other form of data or media (i.e. added media) that might be embedded into networked content or publisher media.

The backend component 560 includes a Retrieve Function 561. Through interaction with third party APIs, downloaded files, data feeds, File Transport Protocol (FTP) data transfers, web crawls and other methods, the backend component 560 retrieves data and media from other sources such as websites, server computers, data storage devices, and/or from any other data or media sources. In a particular embodiment, these retrievals can include ads or other added media elements that will ultimately be integrated into networked content. The backend component 560 also accepts submission of media and data from other sources through APIs, uploaded files, data feeds, FTP, web submissions and other methods.

The retrieval of this data by the Retrieve Function 561 of the backend component 560 can be configured as either an automatic or a manual process. For example, the backend component 560 may access a database of web widget software through an API. This access and retrieval of web widget software can enable users to embed these widgets into their publisher media without interacting with the source code of the widgets themselves.

In another example, the Retrieve Function 561 of the backend component 560 can be configured to automatically crawl one or more merchant websites and keep track of, for example, products, specific Uniform Resource Locators (URLs) and prices. Then, a publisher can incorporate this data into their site to build something like a comparison pricing engine for a product on multiple merchant pages.

As described above, the backend component 560 can use 3^{rd} party API's to retrieve information and content for structured storage in the database 518. In addition, the backend component 560 can provide an API through which 3^{rd} parties may access the aggregated data retained in database 518. In this manner, authorized 3^{rd} parties may query and retrieve data from database 518.

The backend component 560 includes an Organize Function 562. Once the data has been retrieved using the Retrieve Function 561, the Organize function 562 can be used to perform a number of tasks on the retrieved data. First, the retrieved data can be compared against existing data. Duplicative or extraneous data can be scrubbed and cleaned. Next, the retrieved data can be normalized, if necessary, to make the retrieved data more consistent and more easily searchable relative to the existing data. Further, the retrieved data can be structured into indexes and databases and filed for easy retrieval. For example, when downloading a data collection from a source where data had been previously accessed, the Organize function 562 of the backend component 560 can mark changes, discontinue data that is no longer active, and define relationships with other data. Once the data is organized, the collected data and media is stored in easily accessible formats so it can be readily accessed.

When requests are made to the backend component 560 by the GUI 502, User's Client Browsers, Third party applications (such as accounting programs, analytics, data management and so forth), or any other source, the backend component 560 transmits the data it stores. For example, a publisher interacting with the backend component 560 may want to search for pictures through the GUI 502. After searching through the backend component database 518, the publisher can select an image, and perhaps create a caption for the image. The selected image and optional caption can then be incorporated into their publisher media using the various embodiments described herein.

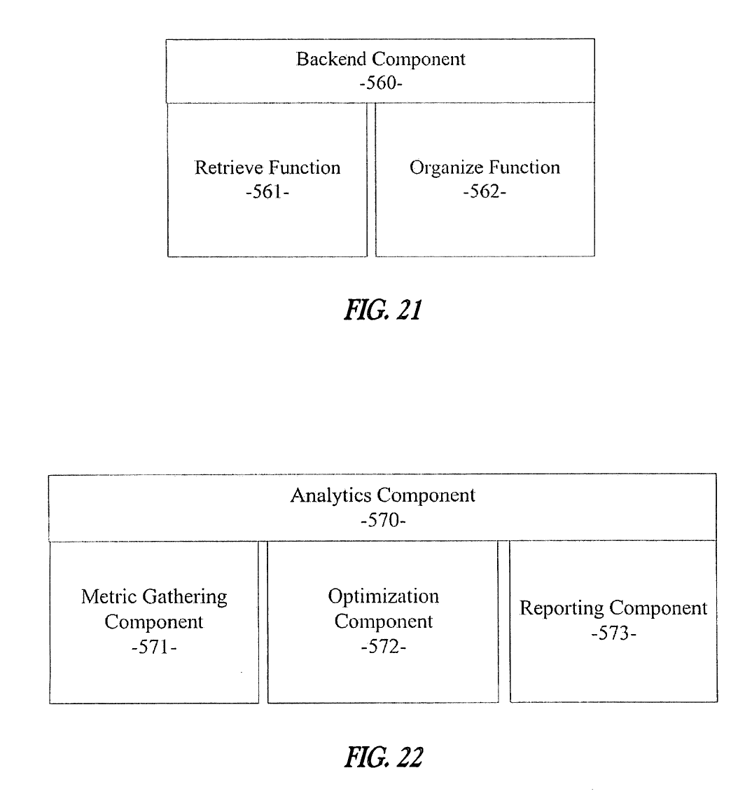

Referring to FIG. 22, the components of a particular embodiment of the analytics component 570 are shown. Various embodiments include an analytics component 570 to measure visitor response to the media generated and displayed to them, test various configurations and placements of media objects, and report the data performance of the media elements to the Publisher 301. An important aspect of this function is to record visitor interaction with the media on a very granular level by generating a set of analytics. These analytics include measuring metrics like the following, for example:
i. Impressions—How many Visitors view the media.
ii. Time Spent—How long did they view the media.
iii. Traffic patterns—Where did they come from and where did they go.
iv. Clicks—Did they click on any of available links.
   1. Click through rate—If the hope is to get them to click on a link or set of links how many people did this.
v. Scrolling—Did they scroll down the page.
vi. Interaction with controls—did they use any of the controls in the media.
vii. Entering data/performing action—did they submit any data or another predefined action.
viii. Cursor movement—where did their cursor go (this includes time spent hovering over objects etc).

Each item of this analytics data is all collected, organized, and stored in the backend component databases 518 by the metric gathering component 571. Using the data collected by the metric gathering component 571 of analytics component 570 as described above, the optimization component 572 can optimize the configuration of the media objects, test different media objects, and generally rework the media with the intention of achieving desired outcomes. For example, the analytics data can be used to re-configure the media to generate the most clicks/actions/views etc.

One way this can be done is to select individual media or categories of media to be alternately displayed. Using the analytics data about the Visitor interaction with each media item, it is possible to determine the best media for achieving desired results. The media can also be presented in alternate configurations and formats to determine which ones are most effective for achieving desired results. Certain conditions can also be identified where one media may work better than another. For example, at night one media may be better and in the daytime, a different media might work best. Using the analytics data, the optimization component 572 can suggest various templates, layouts, configurations etc. to achieve a desired result.

Various embodiments also include a reporting component 573. The function of the reporting component 573 and related interface is to enable the publisher visibility into the analytics data to enable them to make changes and to optimize the media presentation on their site.

Using the various embodiments described herein, the publisher 301 is able to incorporate, transfer and make use of meta-data as part of the publisher webpage code to assist in the targeting of the added media to different users or consumers of the networked content. For example, the publisher 301 can use meta-data to indicate the display of one version of the added media for users in the U.S. and another version for users outside of the U.S. More importantly, every element of the publisher media can be thus tagged with meta-data and reconfigured as discrete elements in different forms to best suit the user. In advertising, this can be used to show certain types of 3^{rd} party content to particular users most likely to be interested in them based on meta-data associated with the user.

Once the publisher 301 has marked changes to be made to the publisher media as captured in the annotations 506, the various embodiments described herein then serve the function of displaying those changes to the users/consumers of the publisher media. The annotations 506 indicating the proper changes to make to the publisher media are stored in a backend database 518 by the DMI 500, which then transmits the changes whenever a user via client viewer 307 interacts with the publisher media 512. This transmitting is done in real time whenever a user requests the publisher media 512 so that the user/consumer is largely unaware that the various embodiments are functioning to change publisher media 504 from its coded form (code that comprises the publisher media and hosted by the publisher or its agents) to a form 512 that includes added media.

Because the various embodiments described herein are able to reconfigure the publisher media in real time and in any form, the various embodiments can serve as a functional dynamic optimization tool. This means that based on the results of the interaction with the publisher media by previous users as well as the current user, the elements of the publisher media can be reconfigured to better serve the users/consumers or better serve the publisher. For example, if a web service tool is placed in one location in the publisher media and is used less than a comparable web service tool that is placed in the same located in an A/B alternation pattern, then the more popular service can be subsequently displayed more frequently. The same optimization principle can be used for testing and optimizing elements themselves, positions, colors, shapes, sizes and every other aspect of the publisher media. The analytics data created by the interaction of the users with the publisher media can be used to make the publisher media better.

As a result of the analytics data collected by the various embodiments, the publisher is able to analyze and efficiently use the data. The various embodiments described herein thus can provide data about user's interaction, optimizations, targeting and position in a manner that enables the publisher to search for anomalies, patterns, problems, opportunities or anything else useful that might be learned, tested or alerted. This analytics package can also function to suggest possible changes to the publisher media by looking at available data and comparing the data with the current publisher media.

One important advantage of the various embodiments described herein is the ability to completely change the way a piece of networked content is viewed without actually editing the source code of the networked content after the first time. This innovation enables another set of innovations such as dynamic optimization, targeting and serving that are not possible in the current paradigm.

One advantage of the various embodiments described herein in regards to media editing is that a non-technical user (defined as someone who is unable or unwilling to edit the source code of the networked content) can add elements, edit existing elements and integrate third party services into the networked content without having to interact with the source code of the networked content. This feature of the various embodiments also enables faster and more efficient changes to be made to the publisher media. Thus, a user can quickly iterate through many changes in response to media user feedback and easily test many options and solutions. Using templates, programmatically created suggestions, and other devices for assisting the user, the various embodiments described herein can enable the creation of more effective, usable, and popular media content. This process can also be amplified by collecting user data created by a collection of users of the tool and other users of the media. This data enables the various embodiments described herein to suggest best practices and solutions that other users have found helpful. Moreover, because some of the various embodiments described herein use a graphical user interface, it is possible to easily integrate other third party editors and tools using API's so that the user can leverage multiple tools in one place. Another advantage of this sort of media editing is that it enables a large class of people who previously were unable to operate at this level of media creation and manipulation.

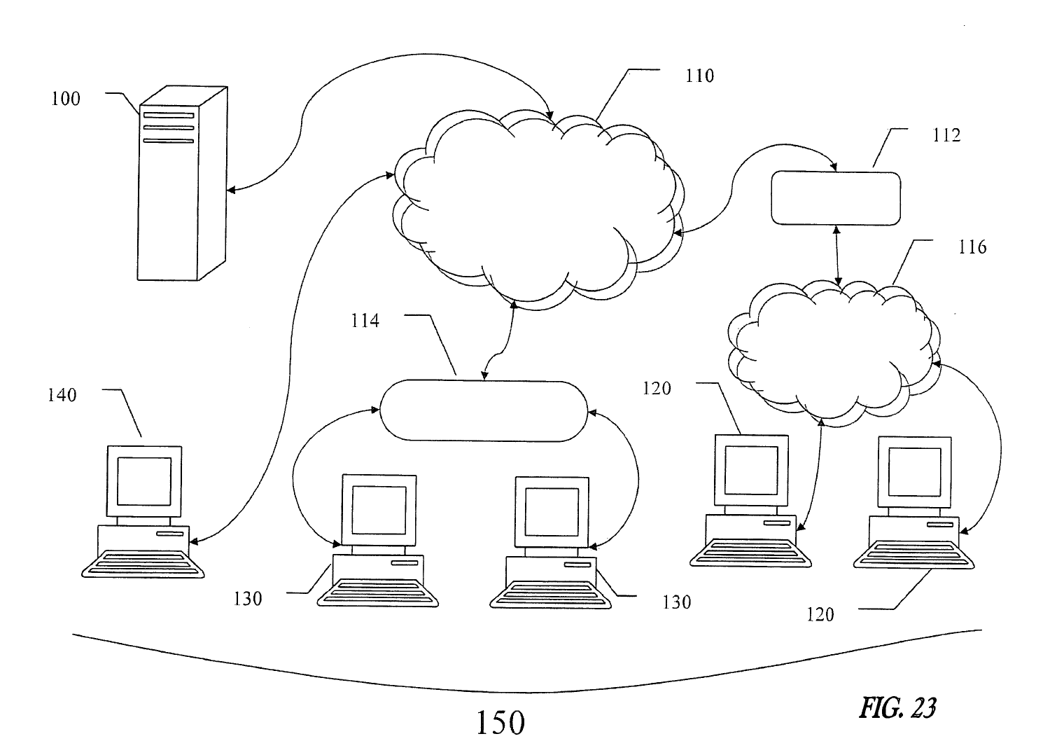

Referring now to FIG. 23, a diagram illustrates a network environment in which various example embodiments may operate. In this conventional network architecture, a server computer system 100 is coupled to a wide-area network 110. Wide-area network 110 includes the Internet, or other proprietary networks, which are well known to those of ordinary skill in the art. Wide-area network 110 may include conventional network backbones, long-haul telephone lines, Internet service providers, various levels of network routers, and other conventional means for routing data between computers. Using conventional network protocols, server 100 may communicate through wide-area network 110 to a plurality of client computer systems 120, 130, 140 connected through wide-area network 110 in various ways. For example, client 140 is connected directly to wide-area network 110 through direct or dial-up telephone or other network transmission line. Alternatively, clients 130 may be connected through wide-area network 110 using a modem pool 114. A conventional modem pool 114 allows a plurality of client systems to connect with a smaller set of modems in modem pool 114 for connection through wide-area network 110. In another alternative network topology, wide-area network 110 is connected to a gateway computer 112. Gateway computer 112 is used to route data to clients 120 through a local area network (LAN) 116. In this manner, clients 120 can communicate with each other through local area network 116 or with server 100 through gateway 112 and wide-area network 110.

Using one of a variety of network connection means, server computer 100 can communicate with client computers 150 using conventional means. In a particular implementation of this network configuration, a server computer 100 may operate as a web server if the Internet's World-Wide Web (WWW) is used for wide area network 110. Using the HTTP protocol and the HTML coding language across wide-area network 110, web server 100 may communicate across the World-Wide Web with clients 150. In this configuration, clients 150 use a client application program known as a web browser such as the Internet Explorer™ published by Microsoft Corporation of Redmond, Wash., the user interface of America On-Line™, or the web browser or HTML renderer of any other supplier. Using such conventional browsers and the World-Wide Web, clients 150 may access image, graphical, and textual data provided by web server 100 or they may run Web application software. Conventional means exist by which clients 150 may supply information to web server 100 through the World Wide Web 110 and the web server 100 may return processed data to clients 150.

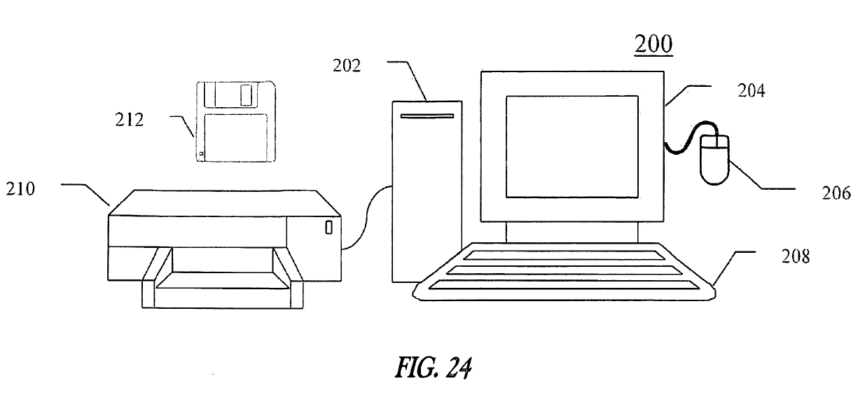

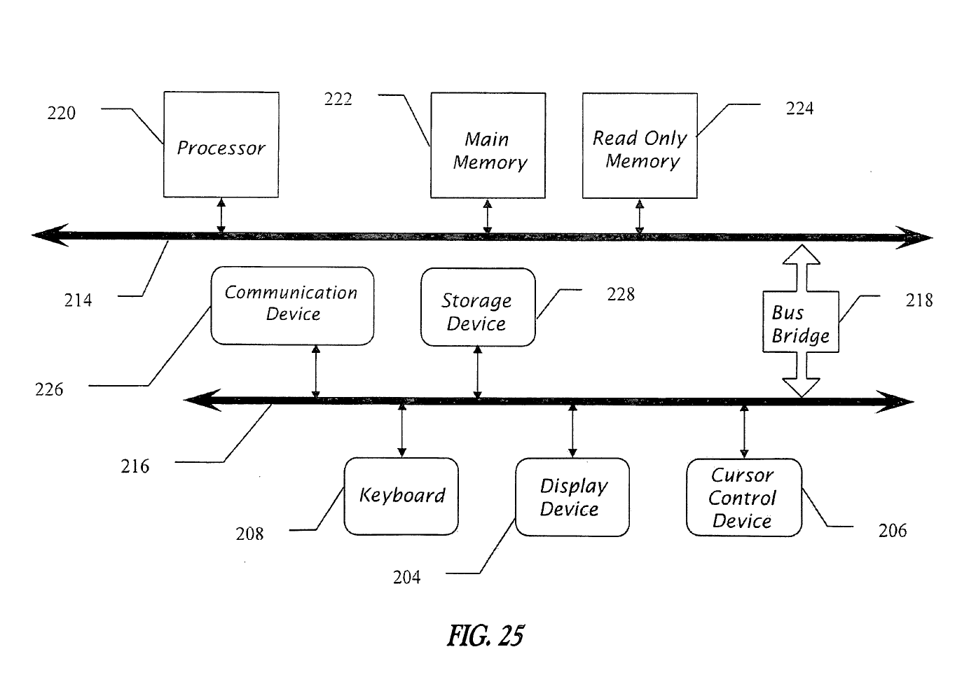

Having briefly described one embodiment of the network environment in which an example embodiment may operate, FIGS. 24 and 25 show an example of a computer system 200 illustrating an exemplary client 150 or server 100 computer system in which the features of an example embodiment may be implemented. Computer system 200 is comprised of a bus or other communications means 214 and 216 for communicating information, and a processing means such as processor 220 coupled with bus 214 for processing information. Computer system 200 further comprises a random access memory (RAM) or other dynamic storage device 222 (commonly referred to as main memory), coupled to bus 214 for storing information and instructions to be executed by processor 220. Main memory 222 also may be used for storing temporary variables or other intermediate information during execution of instructions by processor 220. Computer system 200 also comprises a read only memory (ROM) and/or other static storage device 224 coupled to bus 214 for storing static information and instructions for processor 220.

An optional data storage device 228 such as a magnetic disk or optical disk and its corresponding drive may also be coupled to computer system 200 for storing information and instructions. Computer system 200 can also be coupled via bus 216 to a display device 204, such as a cathode ray tube (CRT) or a liquid crystal display (LCD), for displaying information to a computer user. For example, image, textual, video, or graphical depictions of information may be presented to the user on display device 204. Typically, an alphanumeric input device 208, including alphanumeric and other keys is coupled to bus 216 for communicating information and/or command selections to processor 220. Another type of user input device is cursor control device 206, such as a conventional mouse, trackball, or other type of cursor direction keys for communicating direction information and command selection to processor 220 and for controlling cursor movement on display 204.

Alternatively, the client 150 can be implemented as a network computer or thin client device. Client 150 may also be a laptop or palm-top computing device, such as the Palm Pilot™. Client 150 could also be implemented in a robust cellular telephone, where such devices are currently being used with Internet micro-browsers. Such a network computer or thin client device does not necessarily include all of the devices and features of the above-described exemplary computer system; however, the functionality of an example embodiment or a subset thereof may nevertheless be implemented with such devices.

A communication device 226 is also coupled to bus 216 for accessing remote computers or servers, such as web server 100, or other servers via the Internet, for example. The communication device 226 may include a modem, a network interface card, or other well-known interface devices, such as those used for interfacing with Ethernet, Token-ring, or other types of networks. In any event, in this manner, the computer system 200 may be coupled to a number of servers 100 via a conventional network infrastructure such as the infrastructure illustrated in FIG. 23 and described above.

The system of an example embodiment includes software, information processing hardware, and various processing steps, which will be described below. The features and process steps of example embodiments may be embodied in articles of manufacture as machine or computer executable instructions. The instructions can be used to cause a general purpose or special purpose processor, which is programmed with the instructions to perform the steps of an example embodiment. Alternatively, the features or steps may be performed by specific hardware components that contain hard-wired logic for performing the steps, or by any combination of programmed computer components and custom hardware components. While embodiments are described with reference to the Internet, the method and apparatus described herein is equally applicable to other network infrastructures or other data communications systems.

Various embodiments are described herein. In particular, the use of embodiments with various types and formats of user interface presentations and/or application programming interfaces may be described. It will be apparent to those of ordinary skill in the art that alternative embodiments of the implementations described herein can be employed and still fall within the scope of the claimed invention. In the detail herein, various embodiments are described as implemented in computer-implemented processing logic denoted sometimes herein as the “Software”. As described above, however, the claimed invention is not limited to a purely software implementation.

Thus, systems and methods for dynamic media integration into networked content are disclosed. While the present invention has been described in terms of several example embodiments, those of ordinary skill in the art will recognize that the present invention is not limited to the embodiments described, but can be practiced with modification and alteration within the spirit and scope of the appended claims. The description herein is thus to be regarded as illustrative instead of limiting.

What is claimed is:

1. A method comprising:
inserting a trigger into publisher media;
receiving a request for access to a graphical user interface from a publisher;
receiving, via the graphical user interface, publisher instructions for modifying publisher media;
creating an annotation corresponding to the publisher instructions; and
editing publisher web pages as view by a client browser when the trigger is activated.

2. The method as claimed in claim 1 wherein the publisher instructions include a publisher-specified region in the publisher media.

3. The method as claimed in claim 1 wherein the publisher instructions include a publisher-specified item of 3^{rd} party content.

4. The method as claimed in claim 1 wherein the annotation is stored in a database.

5. The method as claimed in claim 1 wherein the annotation includes information identifying a publisher-specified item of 3^{rd} party content.

6. The method as claimed in claim 1 wherein the trigger includes a link to a dynamic media integrator site.

7. The method as claimed in claim 1 including capturing analytics information related to usage of the publisher media by users.

8. The method as claimed in claim 1 including receiving and storing an item of 3^{rd} party content.

9. A method comprising:
requesting access to a dynamic media integrator;
identifying an object in publisher media;
selecting an item of 3^{rd} party content; and
sending, via the dynamic media integrator, publisher instructions for linking the identified object with the selected 3^{rd} party content.

10. The method as claimed in claim 1 wherein the publisher instructions include a publisher-specified region in the publisher media.

11. An article of manufacture comprising a machine-readable storage medium having machine executable instructions embedded thereon, which when executed by a machine, cause the machine to:
insert a trigger into publisher media;
receive a request for access to a graphical user interface from a publisher;
receive, via the graphical user interface, publisher instructions for modifying publisher media;
create an annotation corresponding to the publisher instructions; and
edit publisher web pages as viewed by a client browser when the trigger is activated.

12. The article of manufacture as claimed in claim 11 wherein the publisher instructions include a publisher-specified region in the publisher media.

13. The article of manufacture as claimed in claim 11 wherein the publisher instructions include a publisher-specified item of 3^{rd} party content.

14. The article of manufacture as claimed in claim 11 wherein the annotation is stored in a database.

15. The article of manufacture as claimed in claim 11 wherein the annotation includes information identifying a publisher-specified item of 3^{rd} party content.

16. The article of manufacture as claimed in claim 11 wherein the trigger includes a link to a dynamic media integrator site.

17. The article of manufacture as claimed in claim 11 being further configured to capture analytics information related to usage of the publisher media by users.

18. The article of manufacture as claimed in claim 11 being further configured to receive and store an item of 3^{rd} party content.

19. An article of manufacture comprising a machine-readable storage medium having machine executable instructions embedded thereon, which when executed by a machine, cause the machine to:
request access to a dynamic media integrator;
identify an object in publisher media;
select an item of 3^{rd} party content; and
send, via the dynamic media integrator, publisher instructions for linking the identified object with the selected 3^{rd} party content.

20. The article of manufacture as claimed in claim 19 wherein the publisher instructions include a publisher-specified region in the publisher media.
